(19) United States
(12) Patent Application Publication
(10) Pub. No.: US 2009/0084723 A1
(43) Pub. Date: Apr. 2, 2009

(54) FASTENING STRUCTURE HAVING TWO MEMBERS AND FLUID FILTER THAT USES THE SAME

(75) Inventors: Tsutomu HANASE, Aichi-ken (JP); Masahiro TOMITA, Aichi-ken (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/177,325

(22) Filed: Jul. 22, 2008

(30) Foreign Application Priority Data
Sep. 27, 2007 (JP) 2007-252529

(51) Int. Cl. B01D 35/31; F16D 1/06

(52) U.S. Cl. 210/232; 403/7

(57) ABSTRACT

The present invention provides a fastening structure having two members that can prevent an axial force from decreasing due to thread loosening even at a temperature that is higher than that during tightening, and that always maintains a firmly fastened state. The fastening structure having two members comprises a first member that has a high thermal expansion rate is provided with an abutting portion on the distal end side of a threaded portion thereof, and a second member that has a low thermal expansion rate is provided with an abutted portion that is abutted by the abutting portion on the proximal end side of a thread-receiving portion. In such a fastening structure, as the temperature becomes higher, the threaded portion is more tightly clasped and compressed by the thread-receiving portion and the abutted portion. As a result, the fastening force between two members increases, and the axial force becomes large.

### BACKGROUND OF THE INVENTION

1. [Field of the Invention]

The present invention relates to a fastening structure having two members in which the two members that have different thermal expansion rates are threaded by using relative rotation, the two members being, for example, a metal base and a synthetic resin cap or the like that form the casing of a fluid filter for an oil filter or the like, and a fluid filter that uses the same. In particular, the present invention relates to a fastening structure having two members that can prevent the axial force from decreasing due to the threads loosening even at a temperature that is higher than the temperature during tightening, and can always maintain a firm fastened state, and to a fluid filter that uses the same.

2. [Description of the Related Art]

Conventionally, two members having different thermal expansion rates are assembled by being fastened by threading, for example, to form the casing for an oil filter or the like that is assembled by threading a base and a cap made of different materials. As shown in FIG. 4, an oil filter 21 that is provided with a conventional casing 4, where the casing 4 includes a closed-end cylindrical cap 2 that is made of a synthetic resin and a base 3 that is made of an aluminum alloy, and these can be threaded together by being rotated relative to each other. A threaded portion 2a that includes a male screw portion 2b is formed on the outer peripheral surface of the cap 2, and an O-ring 5 is fitted thereon. In addition, a thread-receiving portion 3a that includes a female screw portion 3b is formed on the inner peripheral surface of the base 3. The threaded portion 2a and the thread-receiving portion 3a are threaded together, and when the cap 2 and the base 3 have been threaded with the O-ring interposed therebetween, the inside of the casing 4 is maintained in a fluid tight state.

In addition, on the bottom portion of the base 3, an oil path pipe portion 9 that discharges the oil that is inside of the casing 4 and an inlet 10 that causes oil to flow into the casing 4 are provided. A cylindrical protector 13 that has a plurality of through holes 6 is provided inside the cap 2, and the filter element 11 is installed on the outer periphery of this protector 13. A support spring 7, which includes a coiled spring that urges the protector 13 towards the base 3 side, is provided on the upper portion of a spring receiving unit 14 of the protector 13.

In the oil filter 21 that is structured as described above, generally the casing 4 is assembled by threading the male screw portion 2b of the threaded portion 2a of the cap 2 into the female screw portion 3b of the thread-receiving portion 3a of the base 3 at a normal temperature. After the assembly, as shown in FIG. 5, the thread-receiving portion 3a of the base 3 is clasped and compressed by a flange 2d of the cap 2 that is abutted by the end surface 3e of the distal end portion of the base 3 and the threaded portion 2a of the cap 2, and thereby an axial force P, which is a compression force in an axial direction, is generated. Thereby, the cap 2 and the base 3 are fastened by being firmly tightened (refer to Patent Document 1).

Patent Document 1: Japanese Patent Application No. JP-A-2007-160159

However, in the conventional oil filter 21, because the temperature becomes high while the engine is being used for vehicle travel and the like, the cap 2 and the base 3 undergo thermal expansion. Here, as has been described above, materials that have different material properties are used for the cap 2 and the base 3, and the cap 2, which consists of a synthetic resin, has a higher thermal expansion rate than the base 3, which consists of an aluminum alloy. Thus, as shown in FIG. 6, under a high temperature, the threaded portion 2a that includes the male screw portion 2b of the cap 2 expands so as to become larger than the thread-receiving portion 3a that includes the female screw portion 3b of the base 3. Where the abutting position V2 between the end surface 3e of the distal end portion of the base 3 and the flange 2d of the cap 2 serve as the starting point, the threaded portion 2a expands in an axial direction relative to the thread-receiving portion 3a of the base 3, that is, expands vertically downward in FIG. 6, which shows the fastened state under high temperature. As a result, the fastening force between the threaded portion 2a of the cap 2 and the thread-receiving portion 3a of the base 3 decreases, and there is a tendency in which the axial force P″ that is shown in FIG. 6 becomes lower than the axial force P″ that was present during tightening.

### SUMMARY OF THE INVENTION

[Problems to be Solved by the Invention]

Thus, it is an object of present invention to provide a fastening structure having two members that can prevent the axial force from decreasing due to the threads loosening even at a temperature that is higher than that that during the tightening after assembly by threading, and can always maintain a tight fastened state, and a fluid filter that uses the same.

[Means for Solving Problem]

The present invention is as follows.
1. A fastening structure having two members, in which the two members that have different thermal expansion rates are threaded together by using relative rotation, wherein:

a first member having a high thermal expansion rate is provided with an abutting portion on a distal end side of a threaded portion thereof;

a second member having a low thermal expansion rate is provided with an abutted portion that is abutted by said abutting portion of said first member on a proximal end side of a thread-receiving portion into which said threaded portion is threaded; and

said abutted portion and said thread-receiving portion clasp and compress said threaded portion in an axial direction accompanying said threading so as to generate an axial force.
2. The fastening structure having two members according to 1 above, wherein:

said first member comprises a synthetic resin; and

said second member comprises a metal.
3. The fastening structure having two members according to 1 above, wherein:

said first member is a cap that structures one part of a casing of a fluid filter that accommodates a filter element inside said casing, said casing being partitioned into two; and

said second member is a base that structures the other part of said casing of said fluid filter.
4. The fastening structure having two members according to 2 above, wherein:

said synthetic resin is a polyamide resin that is mixed with glass fibers; and

said metal is an aluminum alloy.
5. The fastening structure having two members according to 2 above, wherein:

said first member is a cap that structures one part of a casing of a fluid filter that accommodates a filter element inside said casing, said casing being partitioned into two; and

said second member is a base that structures the other part of said casing of said fluid filter.
6. The fastening structure having two members according to 4 above, wherein:

said first member is a cap that structures one part of a casing of a fluid filter that accommodates a filter element inside said casing, said casing being partitioned into two; and

said second member is a base that structures the other part of said casing of said fluid filter.
7. A fluid filter, comprising:

a filter element;

a protector that supports said filter element; and

a cap and a base that accommodate said filter element and said protector, and can be threaded together by using relative rotation, wherein

said cap and said base are provided with said fastening structure according to 1 above.
8. The fluid filter according to 7 above, wherein:

said first member comprises a synthetic resin; and

said second member comprises a metal.
9. The fluid filter according to 7 above, wherein:

said cap is said first member; and

said base is said second member.
10. The fluid filter according to 8 above, wherein:

said synthetic resin is a polyamide resin that is mixed with glass fibers; and

said metal is an aluminum alloy.
11. The fluid filter according to 8 above, wherein:

said cap is said first member; and

said base is said second member.
12. The fluid filter according to 10 above, wherein:

said cap is said first member; and

said base is said second member.

[Effect of the Invention]

According to the fastening structure having two members of the present invention, a threaded portion, which is furnished with an abutting portion on the distal end side, is provided on the one member having a high thermal expansion rate, and a thread-receiving portion, which is furnished with an abutted portion that is abutted by the abutting portion, is provided on the proximal end side on the other member having a low thermal expansion rate, and thereby, the threaded portion is clasped and compressed in the axial direction by the abutted portion and the thread-receiving portion while being threaded, and thereby it is possible to generate an axial force. When the two assembled members are placed in a temperature that is higher than the temperature during assembly, even if the threaded portion, which is provided on the member having a high thermal expansion rate, expands relatively to the thread-receiving portion, which is provided on the member having a low thermal expansion rate, the free expansion thereof is prevented by the thread-receiving portion and the abutted portion that are provided on the member having a low thermal expansion rate. Thus, as the temperature becomes higher, the threaded portion becomes clasped and strongly compressed by the thread-receiving portion, which is the member with a low thermal expansion rate, and the abutted portion. As a result, the fastening force between the two members increases and the axial force becomes large. Therefore, generally, after the two members having different thermal expansion rates have been fastened by threading at a normal temperature, even when placed in a temperature that is higher than the temperature during fastening, the fastening force between the two members does not decrease and the axial force is not reduced, and it is always possible to maintain a strong fastened state between the two members.

In addition, in the case in which the member having the high thermal expansion rate is made of a synthetic resin and the member having the low thermal expansion rate is made of a metal, for the one member, it is possible to take advantage of the effects that are due to the synthetic resin, that is, the effects of being light-weight and having an inexpensive production cost, and for the other member, it is possible to take advantage of the effects that are due to the metal, that is, the effects of having a high strength and rigidity.

Furthermore, in the case in which one of the two members is a cap that structures one of the casings of a fluid filter and the other member is the base of the fluid filter, in a fluid filter that is installed in the engine compartment of a vehicle or the like in which the temperature becomes high during usage, the cap and the base can always be maintained in a strong fastened state.

Due to being provided with the present fastening structure, in the present fluid filter, after assembly, the fastening force between the cap and the base does not decrease even when placed in a temperature that is higher than the temperature during fastening, and it is always possible to maintain a strong fastened state between the cap and the base without the axial force decreasing.

### BRIEF DESCRIPTION OF THE DRAWINGS

FIG. 1 is a cut away cross-sectional drawing that shows an oil filter of the present embodiment;

FIG. 2 is a cross-sectional drawing of the essential elements that shows a state in which a base and a cap of the oil filter of the present embodiment have been assembled at normal temperature;

FIG. 3 is a cross-sectional drawing of the essential elements that shows a fastened state between the base and cap when the oil filter of the present embodiment is at a high temperature;

FIG. 4 is a cut away cross-sectional drawing that shows a conventional oil filter;

FIG. 5 is a cross-sectional drawing of the essential elements that shows a state in which a base and a cap of the conventional oil filter have been assembled at normal temperature; and

FIG. 6 is a cross-sectional drawing of the essential elements that shows a fastened state between the base and the cap when the conventional oil filter is at a high temperature.

### DESCRIPTION OF REFERENCE NUMERALS AND SIGNS

1; oil filter, 2; cap, 2a; threaded portion, 2b; male screw portion, 2c; abutting portion, 3; base, 3a; thread-receiving portion, 3b; female screw portion, 3d; abutted portion, 4; casing and 11; filter element.

### DETAILED DESCRIPTION OF THE PREFERRED EMBODIMENTS

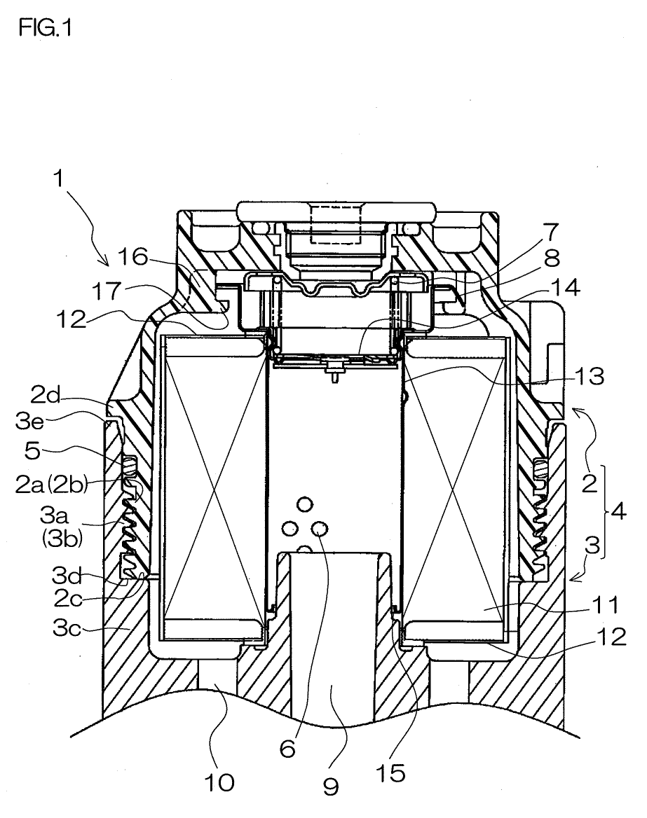

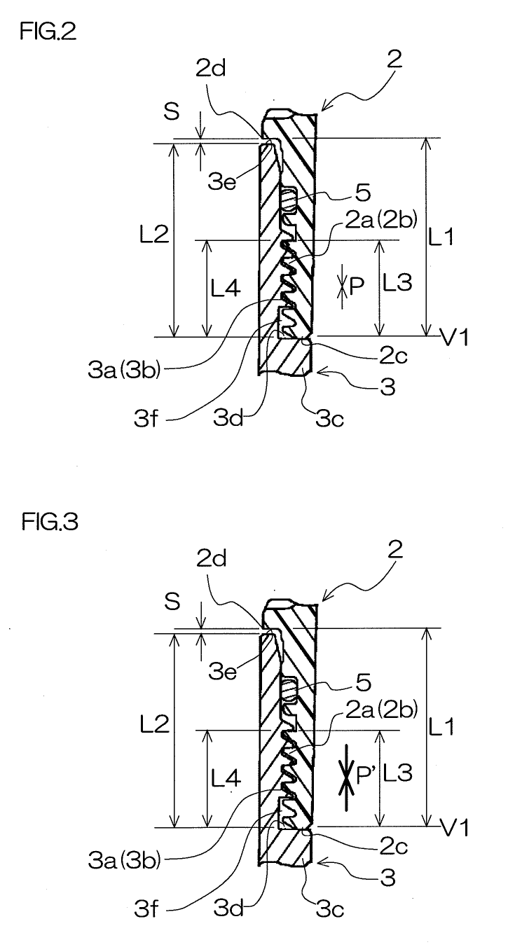

The fastening structure having two members according to the present invention is a fastening structure having two members that are fastened by threading together two members that have different thermal expansion rates by using a relative rotation, wherein, as shown in FIGS. 1 and 2, a first member 2 having a high thermal expansion rate is provided with an abutting portion 2c on the distal end side of a threaded portion 2a, and a second member 3 having a low thermal expansion rate is provided with an abutted portion 3d that is abutted by the abutting portion 2c of the first member 2 at the proximal end side of the thread-receiving portion 3a, into which the threaded portion 2a is threaded.

The fastening structure according to the present invention can be used in any fastening structure having two members, as long as the two members that have different thermal expansion rates are fastened by being threaded together by using a relative rotation, and in particular, can be advantageously used in a fastening structure that is used at locations in which temperature differences occur.

A tank of an internal combustion engine and a cap portion of a container, specifically, the threaded portion of a cap and a base in a fluid filter, and a casing and a drain cap and the like can be provided as examples of a threaded portion. In addition, a threaded portion such as a bushing, for protecting wiring, that is provided in holes that allow extending wiring outside the base, and a base and a cap of an oil filter and a fuel tank can be provided as examples. Furthermore, a threaded portion of, for example, a base and a cap of a fuel tank for a heater or a threaded portion of a cooler box that is made of an insulating material and a cap that is provided on a drain hole thereof can be provided as examples. In particular, the present invention can be advantageously used in the threaded portion of the cap and the base of the fluid filter in which the temperature increases during usage. Even when the present fastening structure is placed in a temperature that is higher than the temperature during assembly, the fastening force between the two members does not decrease and the axial force is not reduced, and it is always possible to maintain a strong fastened state between the two members.

The term “axial force” denotes a compression force and a tensile force that are generated in the axial direction of two members that are fastened by threading by using a relative rotation, and fasten the two members.

Provided that the “two members” each have differing thermal expansion rates and are fastened by being threaded by using a relative rotation, the material, the shape, and the locations of use thereof and the like are not limited in particular. As materials, various stock materials including metals such as an aluminum alloy, synthetic resins such as a polyamide resin, and ceramics can be used. Note that in the case of a synthetic resin, in order to increase the rigidity of the member, a synthetic resin is used that has incorporated therein a reinforcing material such as glass fiber, glass wool, or carbon fiber or the like, depending on necessity. An example can be provided in which the first member is made of a synthetic resin and the second member is made of a metal as a mode in which the members have differing thermal expansion rates. Also, examples can be provided in which the stock material properties differ from each other even if the same synthetic resin or metal is used for both members.

The “threaded portion” of the first member is formed as a male screw or a female screw. The “thread-receiving portion” of the second member is formed as a male screw or a female screw that can be threaded together with the threaded portion by using a relative rotation. Note that the threaded portion and the thread-receiving portion are not limited to screw structures of a female screw and a male screw structure, but, for example, may be a threadable shape in which helical grooves and ridges are formed and fit together in a helical shape. Furthermore, the terms “threaded portion” and “thread-receiving portion” do not simply denote only portions on which the female screw and the male screw are formed, but denote the portions by which the two members are threaded by using a relative rotation.

The “abutting portion” is provided on the distal end of the threaded portion of the member that has a high thermal expansion rate, and generally, is formed by the end surface of the distal end.

The “abutted portion” is provided on the proximal end side of the thread-receiving portion of the member that has a low thermal expansion rate, and is formed by a shape such as a flange or a circular bottom or the like that projects in a circular shape.

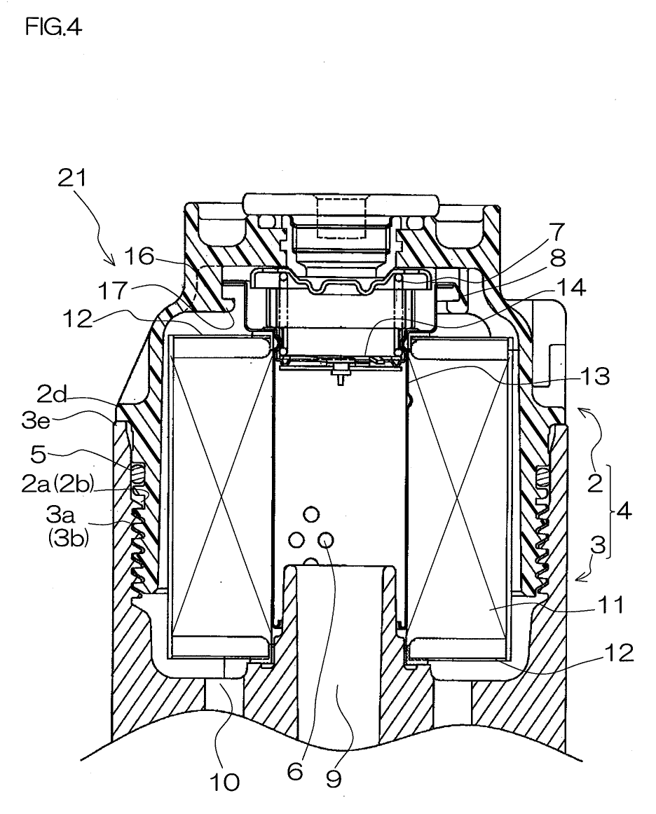

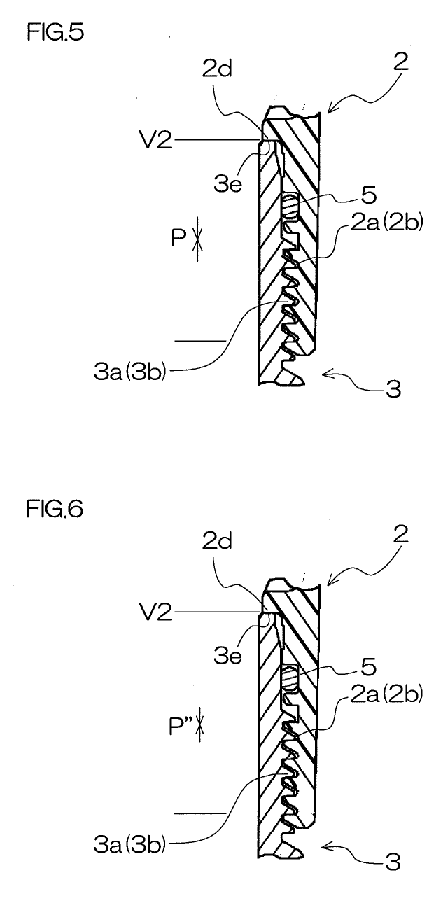

When the present invention is compared to the conventional fastening structure, in the conventional fastening structure having two members, which is shown in FIG. 4 to FIG. 6, the abutting portion is provided on the distal end side of the thread-receiving portion of the member that has the low thermal expansion rate, and the abutted portion, which clasps and compresses the thread-receiving portion of the member that has the low thermal expansion rate, is provided on the proximal end side of the threaded portion of the member that has the high thermal expansion rate. The abutment plane between the abutting portion and the abutted portion is the starting point of the thermal expansion of the two members. In contrast, in the fastening structure having two members of the present invention, the abutting portion is provided on the distal end side of the threaded portion of the member that has the high thermal expansion rate, and the abutted portion, which clasps and compresses the threaded portion of the member that has the high thermal expansion rate, is provided on the proximal end side of the thread-receiving portion of the member that has the low thermal expansion rate. The abutment plane between the abutting portion and the abutted portion is the starting point of the thermal expansion of the two members. Thus, the conventional fastening structure and the fastening structure of the present invention differ on the point that the member provided with the abutting portion and the member provided with the abutted portion are inverted. That is, the two structures differ on whether the abutment plane between the abutting portion and the abutted portion is located on the proximal end side or the distal end side of the threaded portion.

In addition, it is possible to freely select the “synthetic resin”, and a polyamide resin to which a reinforcing fiber such as glass fiber or the like has been incorporated may be provided as an example.

Furthermore, the “metal” can be freely selected, and an aluminum alloy or iron steel may be provided as examples. Among these, an aluminum alloy can be advantageously used because it is light.

The present fluid filter 1 is a filter for a freely chosen fluid such as oil, water or the like. As illustrated in FIG. 1, the fluid filter is provided a filter element 11, a protector 13 that supports the filter element 11, and a cap 2 and a base 3 that accommodate the filter element 11 and the protector 13 and that can be threaded together by using a relative rotation, and the cap 2 and the base 3 are provided with the fastening structure of the present invention.

Provided that the “cap 2” structures a casing 4 that accommodates the filter element 11 and the protector 13 by engaging the base 3, the shape thereof is not particularly limited.

In the “base 3”, typically an inflow path 10 and an outflow path 9 are formed, where the inflow path is for causing the inflow of a fluid from the outside to the inside of the casing 4 and the outflow path 9 is for discharging the fluid to the outside.

The materials of the cap 2 and the base 3 can be freely selected provided that the materials have different thermal expansion rates. Among these, in the case in which the cap 2 includes the male screw and the base 3 includes the female screw, it is advantageous that the cap 2 is a synthetic resin and the base 3 is a metal.

The “filter element 11” is a material for filtering by causing a fluid to pass from the outer peripheral side to the center axial portion, and the material and structure are not particularly limited. In addition, the filter element 11 is a cylindrical body, but the shapes of the outer peripheral side and the inner peripheral side may be similar to each other or be different from each other. Furthermore, provided that one end surface of the center axial portion is open, the other end surface may be opened or closed. Furthermore, the filter element 11 is provided with a sealing member 12 at the portion where the base 3 and a protector 13 come into contact, and thus it is possible to prevent the leakage of the fluid. Provided that the “protector 13” can hold the filter element 11 so as not to be damaged by the pressure of the fluid, the material and the shape thereof can be freely selected. In addition, through holes 6 can be provided such that a fluid can be caused to pass through the protector 13 from the outer peripheral side to the center axial portion.

### Embodiments

Below, the present invention will be explained in detail by the embodiments with reference to the figures. In the present embodiment, a fastening structure having a base and a cap that form a casing of an oil filter that is attached to a cylinder block of an internal combustion engine is used as an example of a “fastening structure having two members”.

As shown in FIG. 1, an oil filter 1 is provided with a casing 4 that includes a closed-bottom cylindrical cap 2 and a closed-bottom cylindrical base 3 that are capable of being threaded together by using a relative rotation. The cap 2 is integrally formed by a synthetic resin such as a polyamide resin that is mixed with glass fibers because this is light-weight and reduces the manufacturing cost. In addition, the base 2 is formed by a die-cast of an aluminum alloy because this ensures the strength of the casing 4 and increases the rigidity.

A threaded portion 2a that includes a male screw portion 2b is formed on an outer peripheral surface of the cap 2, and an abutting portion 2c that abuts an abutted portion 3d of the base 3, which will be described below, is formed on the free end of the threaded portion 2a, that is, the end surface of the opening peripheral edge portion of the closed-bottom cylindrical cap 2.

In contrast, a thread-receiving portion 3a, which includes a female screw portion 3b that can be threaded with the male screw portion 2b of the cap 2, is formed on the inner peripheral surface of the base 3. In addition, a step portion 3c that projects in a circular shape on the inside along the inner peripheral surface of the base 3 is formed on the proximal end side of the thread-receiving portion 3a. Furthermore, the abutted portion 3d that abuts the abutting portion 2c is formed on the upper surface of the step portion 3c, which opposes the abutting portion 2c of the cap 2.

Note that the step portion 3c, on which the abutted portion 3d is formed, is formed so as to project in a circular shape on the inside along the inner peripheral surface of the base 3, but is not limited to this. The step portion 3c may be formed so as to be partitioned into a plurality of segments at intervals in the circumferential direction. Basically, the step portion 3c may have a form that enables functioning as a barrier that abuts the abutting portion 2c of the cap 2 on the proximal end side of the thread-receiving portion 3a of the base 3 so as to prevent the free extension of the threaded portion 2a of the cap 2 caused by thermal expansion, which will be described below.

In contrast, the free end of the thread-receiving portion 3a of the base 3, that is, an end surface 3e on the opening peripheral edge portion of the closed-bottom cylindrical base 3, does not abut a flange 2d formed on the outer periphery of the lid plate portion of the cap 2 that opposes the end surface 3e, and a space S having a prescribed gap is formed so as to be interposed between the flange 2d of the cap 2 and the end surface 3e. Specifically, as shown in FIG. 2, a length L1 from the bottom surface of the flange 2d of the cap 2 to the abutting portion 2c of the threaded portion 2a is longer than a length L2 from the end surface 3e of the distal end portion of the base 3 to the abutted portion 3d, which is provided on the proximal end side of the thread-receiving portion 3a, by an amount that is equivalent to the space S.

Note that the expressions threaded portion 2a of the cap 2 and the thread-receiving portion 3a of the base 3 do not denote only the portions on which the male screw portion 2b and the female screw portion 3b are respectively formed, but denote the portions that include the portions that relate to the threading. Therefore, as shown in FIG. 2 and FIG. 3, a portion on which the female screw portion 3b is not formed is present in a proximity 3f to the abutted portion 3d of the proximal end side of the base 3 in order to provide freedom of machining, and the thread-receiving portion 3a of the base 3 also includes this portion.

An O-ring 5 is fit in the space above the threaded portion 2a of the cap 2 and above the thread-receiving portion 3a of the base 3. In the oil filter 1, when the male screw portion 2b and the female screw portion 3b are threaded such that the cap 2 and the base 3 are threaded with the O-ring 5 interposed therebetween, the inside of the casing 4 is maintained in a fluid-tight state. An oil path pipe portion 9 that discharges the oil inside the casing 4 and an inlet 10 that causes oil to flow to the inside of the casing 4 are provided on the bottom portion of the base 3.

A synthetic resin cylindrical protector 13 having a plurality of through holes 6 is provided on the inside of the cap 2. A cylindrical filter element 11, which is a filter paper that is folded into a chrysanthemum shape, is fit, via a sealing member 12, onto the outer periphery of the protector 13. The protector 13 is provided with a flange portion 8 that is formed on the proximal end side, a spring receiving portion 14 that is formed on the inside portion in the vicinity of the proximal end side, and an oil path communicating portion 15 that is formed on the distal end portion.

The flange portion 8 is detachably supported on a protector holding portion 16 that is formed inside the cap 2, and the release thereof is prevented by a stopper 17 that is formed on the edge portion of the protector holding portion 16. In addition, an engaging structure such as an engaging catch is provided so that the cap 2 and the protector 13 turn integrally. The oil path communicating portion 15 is fit into the oil path pipe portion 9 of the base 3 so as to be able to rotate relatively. Furthermore, a support spring 7 that consists of a coil spring is provided at the upper portion of the spring receiving portion 14 of the protector 13. This support spring 7 urges the protector 13 toward the base 3 side. Due to the urging force of this support spring 7, the sealing member 12 that is provided on the filter element 11 is compressed and the sealing performance are thereby increased.

Next, the fastening of the base and the cap that structure the casing of the oil filter that is structured in this manner and the operation of the fastening structure thereof will be explained.

The assembly and fastening by threading the cap 2 and the base 3 together is generally carried out in an ambient temperature of around 25° C. (5˜35° C.), that is, at a normal temperature. As shown in FIG. 2, in the assembly of the cap 2 and the base 3, the male screw portion 2b of the threaded portion 2a of the cap 2 is threaded into the female screw portion 3b of the thread-receiving portion 3a of the base 3, and when the abutting portion 2c of the distal end side of the threaded portion 2a of the cap 2 abuts on the abutted portion 3d of the proximal end side of the thread-receiving portion 3a of the base 3, the cap 2 is further rotated by a predetermined angle, and the tightening increased. Thereby, the threaded portion 2a of the cap 2 is clasped by the thread-receiving portion 3a of the base 3 and the abutted portion 3d of the base 3, and is subject to a compression force in the axial direction. In contrast, the thread-receiving portion 3a of the base 3 is subject to a tensile force in the axial direction in the outward-facing opposing directions due to the reactive force from the threaded portion 2a of the cap 2. Thereby, an axial force P, which is an axial compression force, is generated at the cap 2, an axial force, which is an axial tensile force, is generated at the base 3, and thereby the cap 2 and the base 3 are firmly fastened.

Next, the fastened state of the cap 2 and the base 3 will be explained with reference to FIG. 3, where the oil filter 1 in which the cap 2 and the base 3 have been assembled as explained above, is in a high temperature state due to engine use during vehicle travel and the like.

The temperatures of the cap 2 and the base 3 become high as the temperature of the oil filter 1 becomes high due to engine use, and both thermally expand in an axial direction, where the abutting position V1, at which the abutting portion 2c on the distal end side of the threaded portion 2a of the cap 2 and the abutted portion 3d on the proximal end of the thread-receiving portion 3a of the base 3 abut, serves as the starting point. A length L3 of threaded portion 2a of the cap 2 becomes L3+ΔL3 due to free expansion due to heat. Here, assuming that the linear expansion coefficient α1 of the cap 2 is constant over the entire range of the temperature change, where the temperature difference between normal temperature and the high temperature is represented by Δt° C., the expansion ΔL3 of the threaded portion 2a of the cap 2 becomes α1·Δt·L3. In addition, a length L4 of the thread-receiving portion 3a of the base 3 becomes L4+ΔL4. Here, assuming that the linear expansion coefficient α2 of the base 3 is constant over the entire range of the temperature change, where the temperature difference between normal temperature and the high temperature is represented by Δt° C., the expansion ΔL4 of the thread-receiving portion 3a of the base 3 becomes α2·Δt·L4. Note that at a normal temperature, the length L3 of the threaded portion 2a of the cap 2 is identical to the length L4 of the thread-receiving portion 3a of the base 3.

However, the thermal expansion rate of the synthetic resin cap 2 is high in comparison to that of the aluminum alloy base 3, and α1>α2. Thus, during free expansion, the expansion ΔL3 of the threaded portion 2a of the cap 2 becomes larger than the expansion ΔL4 of the thread-receiving portion 3a of the base 3. However, the threaded portion 2a of the cap 2 is clasped by the thread-receiving portion 3a and the abutted portion 3d of the base 3, and thereby free expansion is prevented. Thus, even after thermal expansion, a length L3′ of the threaded portion 2a of the cap 2 and a length L4′ of the thread-receiving portion 3a of the base 3 are identical. As a result, the threaded portion 2a of the cap 2 constricts, and is subject to a distortion due to compression by an amount that is equivalent to the amount of the deformation. Consequently, thermal stress in accordance with the distortion is generated. In contrast, the thread-receiving portion 3a of the base 3 expands due to the reactive force from the cap 2, and is subject to a distortion due to the pulling by an amount that is equivalent to the deformation. Consequently, thermal stress in accordance with the distortion is generated. Therefore, the compression force on the threaded portion 2a of the cap 2 increases in comparison to the compression force during normal temperature, and in correspondence to this, the tensile force on the thread-receiving portion 3a of the base 3 also increases in comparison to tensile force during normal temperature. Specifically, as shown in FIG. 3, the axial force P′ increases above the fastening force that is present during normal temperature by an amount equivalent to the added thermal stress, and thus the fastening force increases. Thereby, it is possible to obtain a stronger fastened state without loosening occurring during a high temperature, as happens in the conventional example.

Next, results are shown in which an experiment to compare the fastening strengths of the oil filter of the present invention and the conventional oil filter. In the experiment, after tightening the base and the cap of each of the oil filter of the present invention and the conventional oil filter by using an identical torque at a normal temperature of 25° C., under a high temperature condition of 130° C., the fastening strengths of the oil filters were compared by measuring each torque that was necessary in order to loosen the cap from the base.

As a result, the torque of the conventional oil filter immediately after tightening at a normal temperature of 25° C. decreased by about half at a high temperature of 130° C. In contrast, the torque of the oil filter of the present invention immediately after tightening at a normal temperature of 25° C. increased by about 1.5 times at a high temperature of 130° C. Thus, it has been confirmed that, in the conventional oil filter, the fastening force decreases when a high temperature is attained, whereas in contrast, in the oil filter of the present invention, the fastening force increases.

What is claimed is:

1. A fastening structure having two members, in which the two members that have different thermal expansion rates are threaded together by using relative rotation, wherein:
a first member having a high thermal expansion rate is provided with an abutting portion on a distal end side of a threaded portion thereof;
a second member having a low thermal expansion rate is provided with an abutted portion that is abutted by said abutting portion of said first member on a proximal end side of a thread-receiving portion into which said threaded portion is threaded; and
said abutted portion and said thread-receiving portion clasp and compress said threaded portion in an axial direction accompanying said threading so as to generate an axial force.

2. The fastening structure having two members according to claim 1, wherein:
said first member comprises a synthetic resin; and
said second member comprises a metal.

3. The fastening structure having two members according to claim 1, wherein:
said first member is a cap that structures one part of a casing of a fluid filter that accommodates a filter element inside said casing, said casing being partitioned into two; and
said second member is a base that structures the other part of said casing of said fluid filter.

4. The fastening structure having two members according to claim 2, wherein:
said synthetic resin is a polyamide resin that is mixed with glass fibers; and
said metal is an aluminum alloy.

5. The fastening structure having two members according to claim 2, wherein:
said first member is a cap that structures one part of a casing of a fluid filter that accommodates a filter element inside said casing, said casing being partitioned into two; and
said second member is a base that structures the other part of said casing of said fluid filter.

6. The fastening structure having two members according to claim 4, wherein:
said first member is a cap that structures one part of a casing of a fluid filter that accommodates a filter element inside said casing, said casing being partitioned into two; and
said second member is a base that structures the other part of said casing of said fluid filter.

7. A fluid filter, comprising:
a filter element;
a protector that supports said filter element; and
a cap and a base that accommodate said filter element and said protector, and can be threaded together by using relative rotation, wherein
said cap and said base are provided with said fastening structure according to claim 1.

8. The fluid filter according to claim 7, wherein:
said first member comprises a synthetic resin; and
said second member comprises a metal.

9. The fluid filter according to claim 7, wherein:
said cap is said first member; and
said base is said second member.

10. The fluid filter according to claim 8, wherein:
said synthetic resin is a polyamide resin that is mixed with glass fibers; and
said metal is an aluminum alloy.

11. The fluid filter according to claim 8, wherein:
said cap is said first member; and
said base is said second member.

12. The fluid filter according to claim 10, wherein:
said cap is said first member; and
said base is said second member.
